(19) United States
(12) Patent Application Publication
(10) Pub. No.: US 2022/0179248 A1
(43) Pub. Date: Jun. 9, 2022

(54) OPTICAL WAVEGUIDE ELEMENT

(71) Applicant: SUMITOMO OSAKA CEMENT CO., LTD., Tokyo (JP)

(72) Inventors: Kenta OISHI, Tokyo (JP); Norikazu MIYAZAKI, Tokyo (JP)

(73) Assignee: SUMITOMO OSAKA CEMENT CO., LTD., Tokyo (JP)

(21) Appl. No.: 17/600,054

(22) PCT Filed: Sep. 26, 2019
(86) PCT No.: PCT/JP2019/037729

§ 371 Date: Sep. 29, 2021

(30) Foreign Application Priority Data
Mar. 29, 2019 (JP) 2019-067738

(51) Int. Cl. G02F 1/035; G02F 1/21; G02F 1/225; G02F 1/03

(52) U.S. Cl. CPC G02F 1/035; G02F 1/212; G02F 2202/20; G02F 1/0316; G02F 1/225

(57) ABSTRACT

Provided is an optical waveguide element that prevents damage to a substrate and improves productivity. In an optical waveguide element in which an optical waveguide (24, 23) is formed on a substrate 1, a groove portion 3 is formed in at least a part of the substrate along an outer periphery 10 of the substrate 1.

### TECHNICAL FIELD

The present invention relates to an optical waveguide element, and more particularly to an optical waveguide element in which an optical waveguide is formed on a substrate.

### BACKGROUND ART

In the field of optical communication and the field of optical measurement, an optical waveguide element such as an optical modulator in which an optical waveguide is formed on a substrate made of lithium niobate (LN) or the like and having an electro-optic effect is often used. A substrate forming an optical waveguide element is processed into a thin plate of 30 μm or less, more preferably 20 μm or less, and thus it becomes easy to perform velocity matching between a microwave that is a modulation signal and a light wave propagating in the optical waveguide, and the electric field efficiency is improved. This is also advantageous for miniaturization of the optical waveguide element in the optical waveguide design.

A substrate processed into a thin plate is bonded to a holding substrate in order to increase the mechanical strength. In that case, a material having a low refractive index and a low dielectric constant different from those of the substrate may be used in consideration of the electric field efficiency or the characteristics of the optical waveguide. In addition, the substrate may be adhered to a substrate made of a material having a refractive index equal to or higher than that of the substrate via a resin layer having a low refractive index, or may be directly bonded to a substrate having a low refractive index layer formed on a surface of the substrate.

An optical waveguide element using a thin plate is very fragile and is difficult to handle during manufacturing because a substrate itself is thin. For example, in a wafer manufacturing step for an element, there is work in which an external force is applied to a substrate, such as contact with a holding jig such as wafer tweezers, a processing step such as polishing or bonding for obtaining a thin plate, and a step of closely contacting a photomask and performing patterning by using photolithography. As a result, minute cracks having occurred on the outer periphery of a wafer or in a part of a surface of the wafer may grow due to factors such as a temperature change or a film stress in the subsequent manufacturing steps, and all elements in the wafer may become defective.

In addition, in a case where a plurality of optical waveguide elements (element chips) formed on one wafer are cut and separated, cracks (substrate cracks) may occur due to the impact applied to a substrate, and other adjacent optical waveguide elements (element chips) may be damaged. In particular, an optical substrate having a cleavage plane in a surface direction, for example, an X-plate LN substrate, has a larger problem because cracks extend along the cleavage plane.

Since a material used for a thin plate that is a substrate having an electro-optic effect and a material for a holding substrate are different from each other, an internal stress is generated due to a difference in the linear expansion coefficient between the two due to a change in environmental temperature when mounted in a housing or the like after a chip is manufactured, and thus the thin plate may be easily damaged. In a case where an optical waveguide provided on a substrate is formed by using a ridge structure, a thin recess portion is formed in the substrate, and thus the mechanical strength of the thin plate is further reduced.

### CITATION LIST

### Patent Literature

[Patent Literature No. 1] Japanese Patent No. 6299170

### SUMMARY OF INVENTION

### Technical Problem

An object of the present invention is to provide an optical waveguide element that solves the above-described problems, prevents damage to a substrate and thus improves productivity.

### Solution to Problem

In order to achieve the object, an optical waveguide element of the present invention has the following technical features.

(1) An optical waveguide element includes an optical waveguide that is formed on a substrate, in which a groove portion is formed in at least a part of the substrate along an outer periphery of the substrate.

(2) In the optical waveguide element according to the above (1), the optical waveguide is formed in a ridge structure provided on a substrate surface.

(3) In the optical waveguide element according to the above (1) or (2), a protruding portion of the substrate that is located inside the substrate with respect to the groove portion and forms the groove portion is also used as an optical waveguide for removing unnecessary light propagating through the substrate.

(4) In the optical waveguide element according to any one of the above (1) to (3), an electrode layer is formed on a surface of at least a part of a protruding portion of the substrate that is located inside the substrate with respect to the groove portion and forms the groove portion.

(5) In the optical waveguide element according to any one of the above (1) to (4), a thickness of the substrate is 20 μm or less.

### Advantageous Effects of Invention

According to the present invention, in the optical waveguide element including an optical waveguide formed on a substrate, a groove portion is formed in at least a part of the substrate along an outer periphery of the substrate. Therefore, it is possible to provide the optical waveguide element that prevents damage to the substrate and thus improves productivity because the progress of a crack inward of the substrate can be prevented at the groove portion even in a case where the crack occurs from the outer periphery side of the substrate.

### BRIEF DESCRIPTION OF DRAWINGS

FIG. 1 is a plan view illustrating an example of an optical waveguide element of the present invention.

FIGS. 2A and 2B are plan views illustrating an example of an optical waveguide provided in the optical waveguide element of FIG. 1.

FIG. 3 is a sectional view illustrating Example 1 of the optical waveguide element of the present invention.

FIG. 4 is a sectional view illustrating Example 2 of the optical waveguide element of the present invention.

FIG. 5 is a sectional view illustrating Example 3 of the optical waveguide element of the present invention.

FIG. 6 is a sectional view illustrating Example 4 of the optical waveguide element of the present invention.

FIG. 7 is a sectional view illustrating an application example of Example 4 in FIG. 6.

FIGS. 8A and 8B are plan views illustrating a wafer state including the optical waveguide element of the present invention, in which FIG. 8A illustrates a case where a crack occurs near the outer periphery of the optical waveguide element, and FIG. 8B illustrates a case where a crack occurs inside the wafer.

### DESCRIPTION OF EMBODIMENTS

Hereinafter, an optical waveguide element of the present invention will be described in detail with reference to suitable examples.

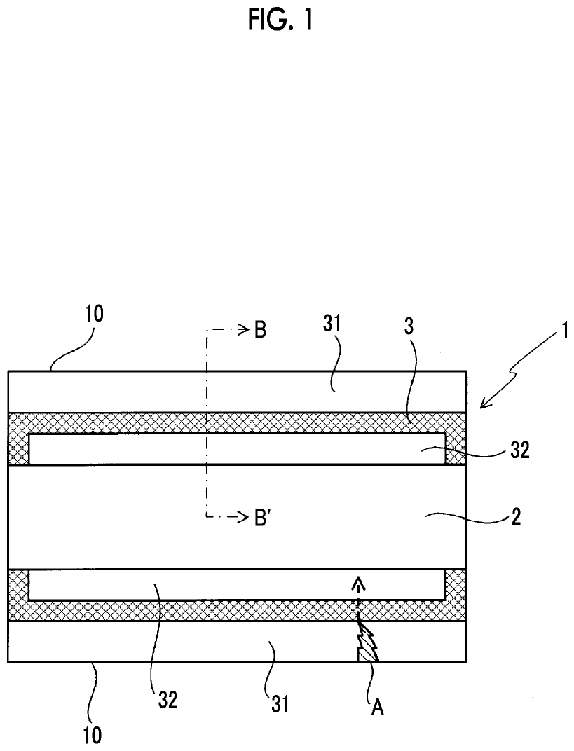

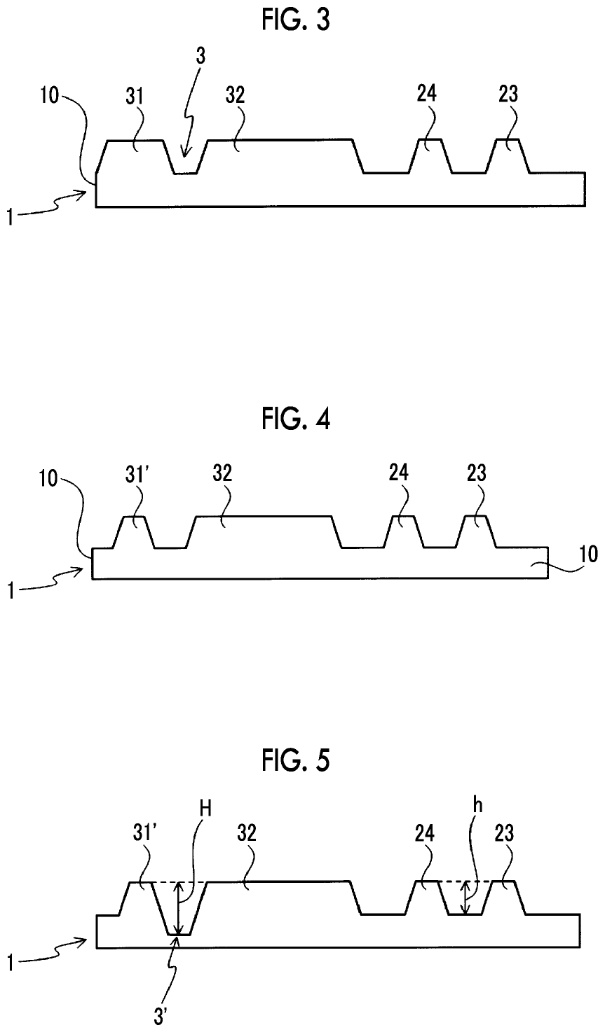

As illustrated in FIGS. 1 and 3, an optical waveguide element of the present invention is an optical waveguide element in which optical waveguides (24, 23) are formed on a substrate 1, and a groove portion 3 is formed in at least a part of the substrate along an outer periphery 10 of the substrate 1.

As the substrate 1 used in the optical waveguide element of the present invention, a substrate made of lithium niobate (LN) or the like and having an electro-optic effect, a semiconductor substrate, or the like may be used. In particular, the present invention can be effectively applied to an X-plate LN substrate in which a cleavage plane is formed along a wafer surface.

As the optical waveguide formed on the substrate 1, a substrate in which a metal such as Ti is thermally diffused on an LN substrate or a substrate in which a substrate surface is processed through dry etching or the like to form a ridge structure may be used. In particular, in a case where the ridge structure is formed, an optical waveguide element (element chip) and a wafer tend to be locally fragile, and thus the present invention can be effectively applied.

The optical waveguide element of the present invention can be suitably applied to an optical waveguide element in which the substrate 1 is easily damaged, the substrate 1 is thin, and the optical waveguide has a ridge structure. A thickness of the substrate 1 is set to 20 μm or less, more preferably 10 μm or less in order to achieve velocity matching between a microwave of a modulation signal and a light wave. In particular, in the ridge structure, a thickness of the substrate at a protruding portion is set to 5 μm or less and a thickness of the substrate at a recess portion is set to 3 μm or less from light propagation characteristics in the optical waveguide.

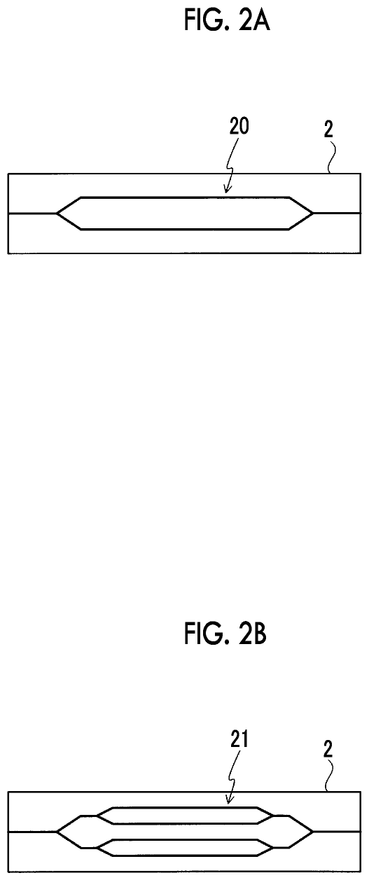

FIG. 1 is a plan view illustrating an example of the optical waveguide element of the present invention. Main portions 2 of the optical waveguide element, such as an optical waveguide, and a control electrode such as a modulation electrode or a DC bias electrode are disposed in the middle of the substrate 1. FIGS. 2A and 2B are diagrams illustrating an example of the optical waveguide formed in the main portions 2 in FIG. 1, FIG. 2A illustrates a single Mach-Zehnder type optical waveguide 20, and FIG. 2B illustrates a nest type optical waveguide 21 in which a plurality of Mach-Zehnder type optical waveguides are incorporated in a nested manner. An optical waveguide such as a DP-QPSK modulator in which even more Mach-Zehnder type optical waveguides are incorporated may be used.

FIG. 3 is a view illustrating a cross section of a part of the substrate taken along a dot chain line B-B′ in FIG. 1, and a part of the optical waveguide formed in the main portions is indicated by the reference numerals 23 and 24. The optical waveguide is formed in a ridge structure. A recess portion is formed in a surface of the substrate 1 to surround the optical waveguides, leaving the optical waveguides (23, 24). A region of a protruding portion 32 extends to a region on the outside where the optical waveguides are not formed.

A feature of the present invention is that the groove portion 3 is formed in a part of the substrate along the outer periphery 10 of the substrate 1. The groove portion 3 may be formed through processing such as dry etching in the same manner as in the ridge structure. The groove portion 3 is formed, and thus the protruding portions (31, 32) are formed on the substrate 1 on both sides or one side of the groove portion 3. The groove 3 may be formed except for an input portion or an output portion of a light wave of the optical waveguide. For example, in a plan view of an element chip, a groove may be formed along a long side near the long side of the rectangular element chip.

Although not illustrated in FIG. 3, a holding substrate made of a glass material, LN, or the like is disposed and fixed on the lower side of the substrate 1. The substrate 1 is bonded to the holding substrate via an adhesive layer such as resin as necessary.

Due to the presence of the groove portion 3, even if a crack A penetrates from the outer periphery of the substrate 1 as illustrated in FIG. 1, the progress of the crack is stopped at the groove portion 3, and thereafter, the crack does not progress toward the inside of the substrate 1 as indicated by a dotted arrow. Therefore, the main portions 2 of the optical waveguide element can be protected from damage and can thus function as the optical waveguide element.

The protruding portion 32 of the substrate, which is located inside the substrate 1 with respect to the groove portion 3 and forms the groove portion 3, may function as a slab waveguide for removing unnecessary light formed in the vicinity of the outer periphery of the substrate as disclosed in Patent Literature No. 1. The protruding portion 32 is processed into a ridge structure in correspondence to a pattern shape of the slab waveguide.

FIG. 4 is a sectional view illustrating Example 2 of the optical waveguide element of the present invention. In FIG. 4, an outer end part of a protruding portion 31′ close to the outer periphery 10 is disposed away from the outer periphery 10. With such a configuration, the thin portion along the outer periphery of the substrate 1 is easily damaged, but the protruding portion 31′ and the protruding portion 32 can prevent cracks from penetrating inward in two stages.

In FIG. 1, the groove portion 3 is formed in the region along the periphery except for the main portions, but the groove portion 3 may be formed only at, for example, corner portions of the substrate or in the vicinity of a portion for gripping the substrate 1 at the time of manufacturing.

FIG. 5 is a sectional view illustrating Example 3 of the optical waveguide element of the present invention. A depth H of the groove portion 3′ is larger than a depth h of the recess portion forming the optical waveguide (23, 24), and thus the mechanical strength of the groove portion 3′ is lower than that of the optical waveguide portion to be more easily damaged, and as a result, the optical waveguide can be protected. The optical waveguide element of the present invention is not limited to those in which the depth of the groove portion 3 (3′) is larger than the depth of the recess portion of the ridge structure forming the optical waveguide. Even if the depth of the groove portion is smaller than the depth of the recess portion of the ridge structure of the optical waveguide, when the mechanical strength is even slightly lower than that of a portion where a crack occurs and spreads, it is possible to suppress the spread of the crack.

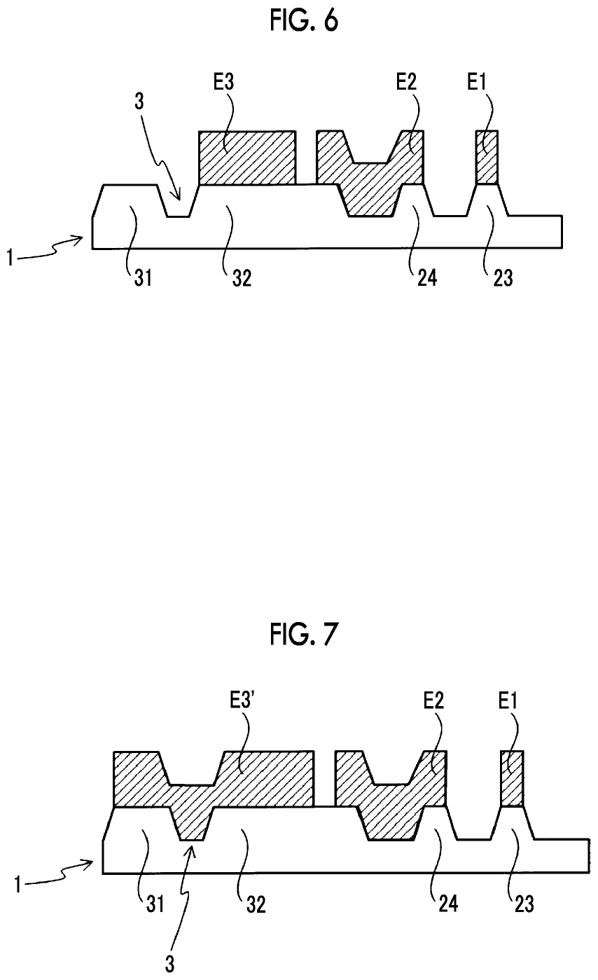

FIG. 6 is a sectional view illustrating Example 4 of the optical waveguide element of the present invention. An electrode layer E3 is formed on a surface of at least a part of the protruding portion 32 of the substrate, which is located inside the substrate 1 with respect to the groove portion 3 and forms the groove portion 3. In the above-described way, the electrode layer is provided on the substrate portion where the mechanical strength is desired to be maintained high, and thus it is possible to more effectively prevent cracks from advancing inside the substrate.

As illustrated in FIG. 7, an electrode layer E3′ may be enlarged and disposed in a region including the groove portion 3. In this case, in addition to being able to suppress the spread of cracks in the groove portion 3, the spread of the cracks can be more suppressed because it is difficult for the cracks of the substrate to progress due to the electrode layer E3′ that is formed in close contact with the substrate. The electrode layer E3′ increases the mechanical strength of the location where the groove portion 3 is disposed to some extent, but the mechanical strength of the location of the groove portion 3 is lower than that of the portion where the groove portion 3 of the substrate 1 is not formed (the ridge structure of the optical waveguide is also not formed), it is possible to suppress the spread of cracks.

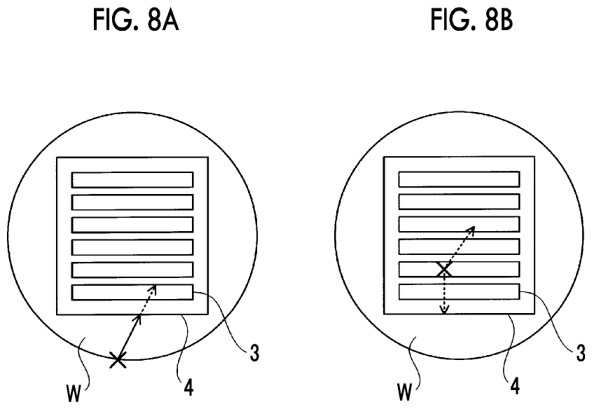

FIGS. 8A and 8B are plan views illustrating a wafer state including the optical waveguide element of the present invention. A plurality of optical waveguide elements (element chips) are formed on a wafer W. The groove portion 3 is formed for each optical waveguide element. Another groove portion 4 may be provided on the outside of these plurality of optical waveguide elements. As illustrated in FIG. 8A, in a case where a crack occurs near the outer periphery of the wafer W (refer to the X mark), even if the crack progresses as indicated by a solid arrow, the groove portion 4 can prevent the progress of the crack inward of the groove portion 4 and can thus protect the optical waveguide element disposed inside the groove portion 4. As illustrated in FIG. 8B, even in a case where a crack occurs in a part of the optical waveguide element, the groove portion 3 can prevent the progress of the crack toward other optical waveguide elements.

### INDUSTRIAL APPLICABILITY

As described above, according to the present invention, it is possible to provide an optical waveguide element that prevents damage to a substrate and improves productivity.

### REFERENCE SIGNS LIST

1 Substrate having electro-optic effect
2 Main portion of optical waveguide element
23, 24 Optical waveguide (ridge structure)
3,3′ Groove portion
31,32 Protruding portion (substrate)
E1 to E3 Electrode layer

1. An optical waveguide element comprising:
an optical waveguide that is formed on a substrate, wherein
a groove portion is formed in at least a part of the substrate along an outer periphery of the substrate.

2. The optical waveguide element according to claim 1, wherein
the optical waveguide is formed in a ridge structure provided on a substrate surface.

3. The optical waveguide element according to claim 1, wherein a protruding portion of the substrate that is located inside the substrate with respect to the groove portion and forms the groove portion is also used as an optical waveguide for removing unnecessary light propagating through the substrate.

4. The optical waveguide element according to claim 1, wherein an electrode layer is formed on a surface of at least a part of a protruding portion of the substrate that is located inside the substrate with respect to the groove portion and forms the groove portion.

5. The optical waveguide element according to claim 1, wherein a thickness of the substrate is 20 μm or less.
